(19) United States
(12) Patent Application Publication
(10) Pub. No.: US 2002/0052860 A1
(43) Pub. Date: May 2, 2002

(54) Internet-mediated collaborative technique for the motivation of student test preparation

(76) Inventor: David Michael Geshwind, New York, NY (US)

Correspondence Address: ANNE C. AVELLONE, 60 WEST 66th St, New York, NY, 10023, US

(21) Appl. No.: 09/996,922

(22) Filed: Oct. 31, 2001

Related U.S. Application Data
(60) Provisional application No. 60/244,714, filed on Oct. 31, 2000.

(51) Int. Cl. G09B 25/00

(52) U.S. Cl. 706/62; 434/365

(57) ABSTRACT

An internet-mediated technique permits the collaboration of parents, educators and advertizing sponsors to motivate student utilization of interactive computer practice sessions with automated assessment and customized presentations for students.

### CROSS REFERENCE TO RELATED APPLICATIONS

This application claims a priority date of Oct. 31, 2000, based on a U.S. Provisional Patent Application No. 60/244,714, filed by the instant Applicant and of the same title.

### BACKGROUND OF THE INVENTION

1. Field of The Invention

The instant invention relates to: the educational psychology of motivating students to perform work, such as routine practice in preparation for standardized tests; the business relationship established between students, parents, educators, and sponsors; and, in most cases, computer and communications technology, such as the internet, to organize and deliver content.

2. Description of Related Art

The field of educational psychology comprises a broad range of (often contradictory) theory, opinion and practice, in areas such as: how best to teach/learn; the appropriate type and value of ‘assessment’; the value of practice or drilling; and, the proper way to motivate learning and practice, particularly the value of reward beyond satisfying a love of learning (e.g., ‘bribing’). Nevertheless, despite the reticence regarding assessment of some educators, parents or students, the reality is that standardized tests such as SATs, GREs, LSATs, MCATs, Achievement Tests, Regents Tests, etc. are required prior to entry into, or certification by, educational institutions.

There are many alternatives, beyond self-motivated self-organized studying, for students to prepare for such tests including: review books, practice exams, vocabulary lists, flashcards and other practice materials; and, review courses, some of which may be provided on-line, such as via the internet, or private tutoring. It is generally acknowledged that such effort is best carried out over an extended period and that crash preparation or ‘cramming’ for standardized tests does not work well. Parents are often more motivated than students to purchase and have utilized such review materials and services. Parents sometimes offer incentives or ‘bribes’ in order to motivate their children to utilize such materials.

Such practice or review materials are sometimes embodied as interactive software, which may be supplied on diskette or CD-ROM, or may be mediated over a communications network such as the internet. The software can employ automated and customized features that may include testing or other assessment of progress.

Interactive communication services often include advertizing, such as internet banner ads, which may offset the cost of services provided to end users.

Those skilled in the arts of the basic technologies and disciplines used to effect the instant invention are: graphic, content, interactive media, computer/human interface, and instructional media and educational technology designers; specialists in cognitive and educational psychology; computer programmers of various sorts, including those well-versed in interactive media, multimedia, educational software and artificial intelligence including expert systems, etc.; telecommunications and network specialists; system integrators and administrators; and the like; with, for many embodiments, particular emphasis on internet- or worldwide web-based systems. The basic technologies and disciplines described peripherally herein are within public knowledge and the ken of those skilled in the appropriate arts and are not, in and of themselves, the subject of the invention disclosed and claimed herein. Rather, the particular business relationships, and system organizations and functions, which are disclosed, illustrated and claimed herein (which, in turn, are enabled by those basic technologies and disciplines) are the subject of the instant invention.

### BRIEF SUMMARY OF THE INVENTION

Interactive educational software, and communication technology such as the internet, are well developed, and the instant invention does not, in general, relate to the enabling details of such basic technology. Rather, the instant invention relates to the business and technical organization of a system, which in turn utilizes such basic technology, to effect a collaborative relationship between parent, educator and advertizing sponsor, for the purpose of motivating students to utilize the inventive system, to prepare for standardized tests, or for other educational purposes.

Many uses of this invention are possible, and details of operation vary among embodiments. A description of typical operation of the invention follows with specific reference to the internet-mediated on-line preparation of high school students for the SATs.

Parents will, optionally, pay, to the educational service bureau, a fee (tuition) for the access of their student to the internet-mediated service. Some of the cost will, optionally, be offset by advertizing sponsors.

In addition to the increased likelihood of student utilization of such a system, many parents (and students) will prefer such a system over review courses held out of the home, particularly in the recent climate where security concerns are heightened.

### BRIEF DESCRIPTION OF THE SEVERAL VIEWS OF THE DRAWING

FIG. 1 depicts a schematic of the various relationships between student, parent, educator and sponsor.

FIG. 2 depicts a system diagram of a typical network mediated, often client/server, functions employed to operate an embodiment of the instant invention.

FIG. 3 depicts a typical database entry of account information.

FIG. 4 depicts a typical database entry of weekly use of the system by one student.

FIG. 5 depicts a typical database entry of the progress report for one student.

FIG. 6 depicts typical database entries of the interaction or progress with one problem type by one student.

FIG. 7 depicts a typical database entry of the structure of one practice problem for presentation to students.

FIG. 8 depicts a typical illustration supplied with a practice problem.

FIG. 9 depicts a typical illustration supplied with a response to a wrong ‘distractor’ answer to a practice problem.

FIG. 10 depicts an exemplary flow diagram for the overall operation of AI educational media system engine in authoring/teaching mode.

FIG. 11 depicts an exemplary flow diagram for the overall operation of AI educational media system engine in presentation/learning mode.

FIG. 12 depicts an exemplary flow diagram of element (1010)—preliminary suggestions to author/teacher.

FIG. 13 depicts an exemplary flow diagram of element (1030)—system analysis and additional suggestions.

FIG. 14 depicts an exemplary flow diagram of element (1330)—response to new term.

FIG. 15 depicts an exemplary flow diagram of element (1340)—response to elsewhere encountered term.

FIG. 16 depicts an exemplary flow diagram of element (1140)—system adjusts level of detail or complexity, type of media of presentation, etc.

FIG. 17 depicts an exemplary flow diagram of element (1170)—actions upon student help request.

### DETAILED DESCRIPTION OF THE INVENTION

The detailed description of the instant invention, with reference to the attached figures, will be made with regard to: a service geared to the preparation of high school juniors for the Scholastic Aptitude Test (SAT) standardized test; a service paid for by the students' parents; and, a service mediated over the public internet. Nevertheless, this discussion, and the accompanying figures, are intended to be illustrative, rather than limiting. Such a service may be used to teach new material, not just be used for review, and may cover any educational subject; it may be paid for by the students themselves (particularly for older or graduate students preparing for GREs, etc., or studying college level or professional material), or it may be partially or entirely sponsor- or grant-supported; it may also be mediated by any suitable communications technology, public or private. In particular, alternatives to operation via the internet include: distribution of programs (via diskette, CD-ROM, etc.) to be run on computer in an off-line non-networked manner; and, through the use of automated voice response and keypad input via telephone system.

Further, although the preferred embodiment involves parents and students, in other embodiments the paying authority is an employer, school administrator, the student himself (as already described, above), etc. In particular, corporate training, professional development, ‘continuing education’ and regulatorily mandated education (e.g. CLE and CME credits) are also amenable to incorporating the instant invention, particularly if mediated by computer and/or telecommunications network.

The problem, briefly, is that parents are often more motivated than their children to have their children prepare to perform well on tests such as the SAT. Parents will spend from $19 for a review book, to hundreds or even thousands for review courses and tutoring. Students, in turn, will often not be motivated to work with these materials, and will not put in time beyond the time actually required to attend review classes. However, particularly for exams such as the SAT, while some test preparation in the form of doing practice tests and learning ‘test taking tricks’ is effective, cramming does not generally work well. Small doses of practice, every or, at least, most days, over a long period of time, is a more effective way to increase scores on such standardized tests.

Practice tests and other review materials or review courses will generally be used in conjunction with the instant invention; these may be provided by the same service as that providing the invention, or from another source. However, the invention as described here, will focus on providing students with the ‘small dose almost every day’ type of practice and—more important—the motivation that will help ensure their use of such a regime. True daily practice may be encouraged by having a particular day's materials available for only a single day and requiring ‘attendance’ Monday through Friday. Alternately, weekend sessions may be used to ‘make up’ for missed weekday sessions; or, sessions may be left up for two or three days so that, for example, if Tuesday's and Wednesday's sessions were missed because a student were unavoidably otherwise engaged, they could make up by doing three sessions on Thursday. Similarly, provision is optionally made for student's to ‘pre-load’ their schedule, if they know they will be unavailable, by doing several sessions ahead of time. However, if such options are made available, it will be necessary to monitor and limit their use; the purpose of the invention is to encourage and motivate frequent manageable-sized practice sessions, not infrequent intensive ‘make up’ sessions.

In standard SAT preparation situations there are three parties: parents, students and an educational service or material. The parents pay for the service or material; the service or material offers opportunity for practice to the student; and, the student is often not sufficiently motivated to take advantage of that opportunity.

In the instant invention a fourth party is involved—a sponsor who supplies some form of reward or incentive (generally merchandise, or a discount for merchandise) to those students who meet some minimum threshold of participation in the educational program.

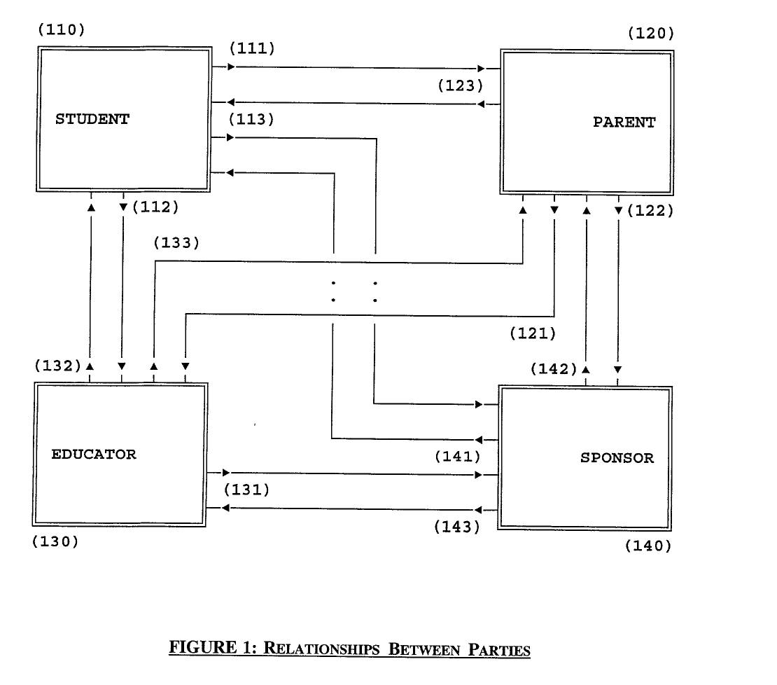

With reference to FIG. 1: the four parties are student (110), parent (120), educator (the service bureau who organizes the enterprise, 130) and sponsor (actually, in general, many such sponsors who supply merchandise and/or discounts, 140). The parent (120) pays (121) the educational service bureau (130) to provide educational content (132) to the student (110). The student (110) practices with the content (1 12) in exchange for receiving rewards or incentives (141) supplied by the sponsor(140). Other rewards (142) may optionally be sent to the parents (120) as well. The sponsor (140) receives exposure, additional purchases, brand loyalty and other promotional benefit (113 & 122) from the student (110) and, optionally, parent (120). The educator (130) provides an audience or list (131) to the sponsor (140) for exposure for its products (via 113 & 122) and may also provide (131) additional promotion in the form of banner ads or other advertizements (113 & 122). The sponsor (140) provides (143) to the educator (130) the merchandise and/or discounts to be used to motivate students (141) as well as, optionally, payment for the exposure and other promotion (143). Finally, the parent (120) receives (133) from the educator (130) reports and assurance that their students (110) are working (112) and learning (111). Parents (120) may then heap praise and encouragement (123) on the students (110) instead of guilt and acrimony.

In this way, each party gets what they desire: diligent students for parents; merchandise and discounts for students; exposure and other marketing benefits for sponsors; and, payment from parents and/or sponsors for the educational service bureau. This is as opposed to the traditional three party system with students feeling put upon, parents feeling their money is wasted, and educational service bureaus resented by both parents and students.

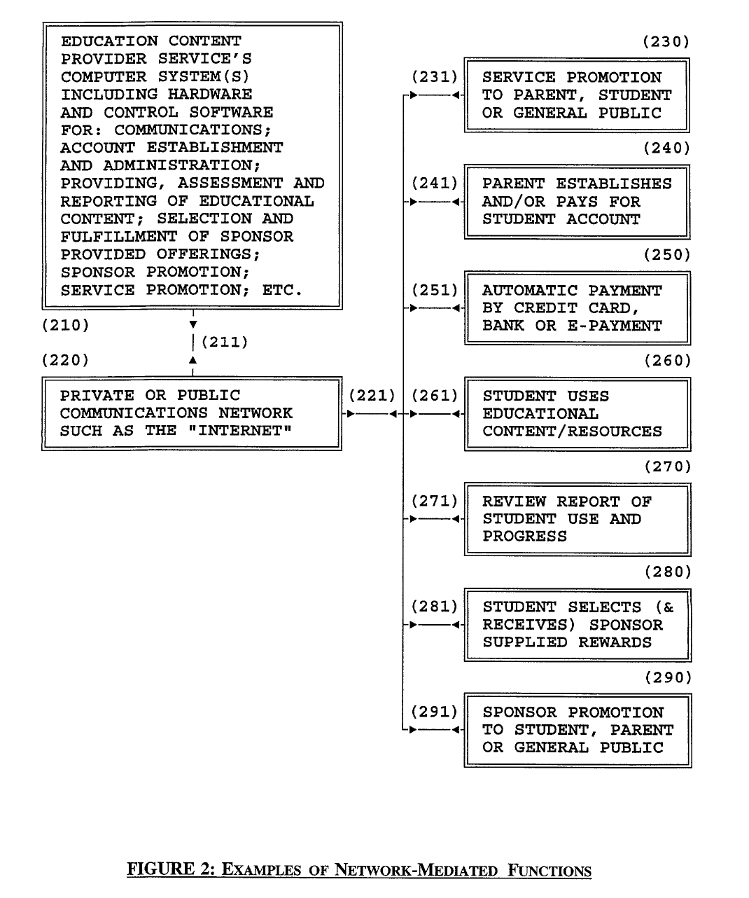

With regard to FIG. 2: the educational service provider maintains a system (210) comprising one or more computers, at least some of which are connected to a network (220) such as the internet by a (bi-directional, as are all the communications lines depicted) communications line (211). The network (220) communicates with other computers (230-290) via another communication line (221) and their communication lines (231-291). All of this communications networking has been simplified and idealized for the purpose of illustration.

This system (210) comprises computer and communications hardware and may be configured as an internal network separate from the communications network (220) used to communicate with the other computers (230-290) depicted. This system (210) also comprises software and databases needed to carry out all the necessary functions including, but not necessarily limited to: communications; advertizing and promotion; automatic account establishment and maintenance; taking and processing automatic payment by credit card, debit card, bank transfer, other electronic payments or electronic commerce mechanisms, etc.; educational content distribution, management, assessment, reporting, tracking, customization, etc.; offering, taking selections, and automatically displaying coupons for, or otherwise automatically causing communications for generating the delivery of, sponsor-supplied merchandise or discounts, or other ‘rewards’ or incentives; customer service communications; worldwide web, EMail, news, FAX generation, and other ‘server’ programs; and all other standard computer and communication system operation, administration and maintenance functions.

This computer system (210) will communicate with many other computers, often in a client/server type of interaction, and the operation of these functions are illustrated in a schematic and simplified way as separate computer nodes (230-290).

Computer terminal (230) is, typically, a worldwide web client running a browsing program and will encounter web pages promoting the educational service. These pages may be directly addressed if the website is known to the end user; may be addressed from information found in print, television or other standard media; or, may be linked to from a search engine, some other website, a banner ad, etc. Similarly, this node may also represent that an electronic advertizement or notice is delivered (e.g., EMail, voicemail or electronic FAX), or a newsgroup notice encountered, etc. In addition, traditional advertizements (print, television, radio, direct mail and other media) other than the network promotion shown by (230) will, in general, also be utilized by the educational service organization.

Promotion/sponsorship may also take the form of strategic partnerships. For example, if a high school (or other appropriate educational institution) distributes promotional information about the inventive service, the school may, in turn, receive: a fixed or sliding referral fee; a fixed or sliding number of full or partial ‘scholarships’ that it may award to students that they feel are particularly worthy or needy (e.g., whose parents will not or can not pay); and/or, the gift or loan of computer equipment so scholarship or all students can utilize the service at the school. Similarly, in conjunction with an SAT review course service, subscribers to the inventive service would receive a discount on (or, at least, receive promotional information about) the review course and/or vice versa. Similarly, in conjunction with the publisher of an SAT review book (or other material) subscribers to the inventive service would receive a discount on (or, at least, promotional information about) the book, and/or the book would include a coupon discounting (or, at least, a notice promoting) the inventive service.

Computer terminal (240) is, again, typically, a worldwide web client running a browsing program, preferably utilizing forms. In this case, establishing an encrypted or secure connection, such as is standard for electronic commerce, will be preferred as electronic payment via credit card, debit card, bank routing and check number, or other electronic commerce mechanism will, generally, be used to affect payment by the parent to establish an account for the student. Of course, it is also possible that payment can be made by traditional means such as mailing a check; via a 900 telephone payment; partial or total sponsor support; scholarship; etc. Parents may also be given options that include a relatively high tuition fee with a service that has little or no advertizing vs. a service with a lower fee and increased amounts of advertizing. Account establishment will also include supplying contact information, selection of which services are desired, selection of which merchandise is appropriate for a particular student, reporting options, (e.g., via EMail, website, telephone, printed and mailed, etc.), etc.

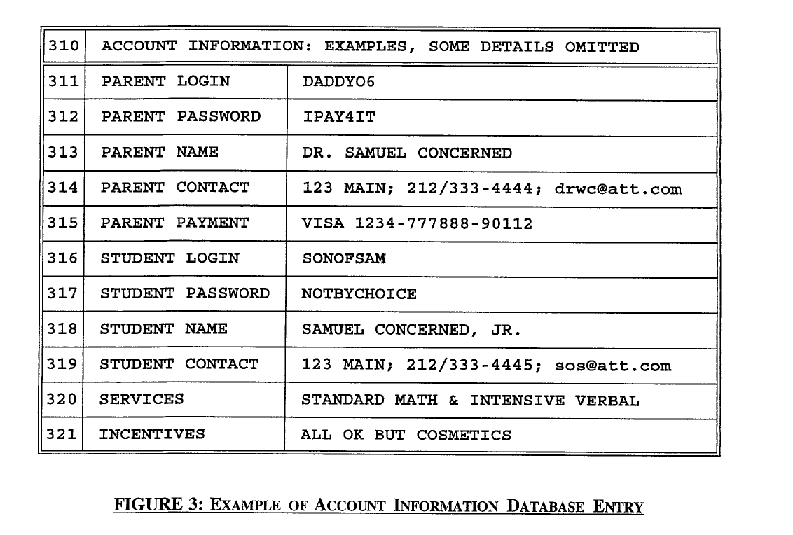

FIG. 3 shows a partial database entry (310) for a typical account including: a login, password, name and contact information for the parent (311-314); a login, password, name and contact information for the student (316-319); payment information (315); service selection (320); and, merchandise limitations (321). Other fields, needed to administer the account, will also be included as determined by those skilled in the art of database system design and administration.

Computer (250) will, generally, be another corporate server operated by a credit card company, bank, electronic commerce service, etc. Electronic payments authorized during operation of (240) and stored in (311-315 & 320) will actually be made via the operation of (250) which may operate in tandem, or asynchronously.

Computer (260) is, again, typically, a worldwide web client running a browsing program, preferably Java compliant. Because this particular function involves significant interactivity, Java is preferable because it permits an entire interactive program to be downloaded to the client, for use by the student, with the final results returned to the server. Otherwise, each element of interactivity will have to be implemented via CGI, or some similar mechanism, which is much clumsier, slower and more prone to network delays.

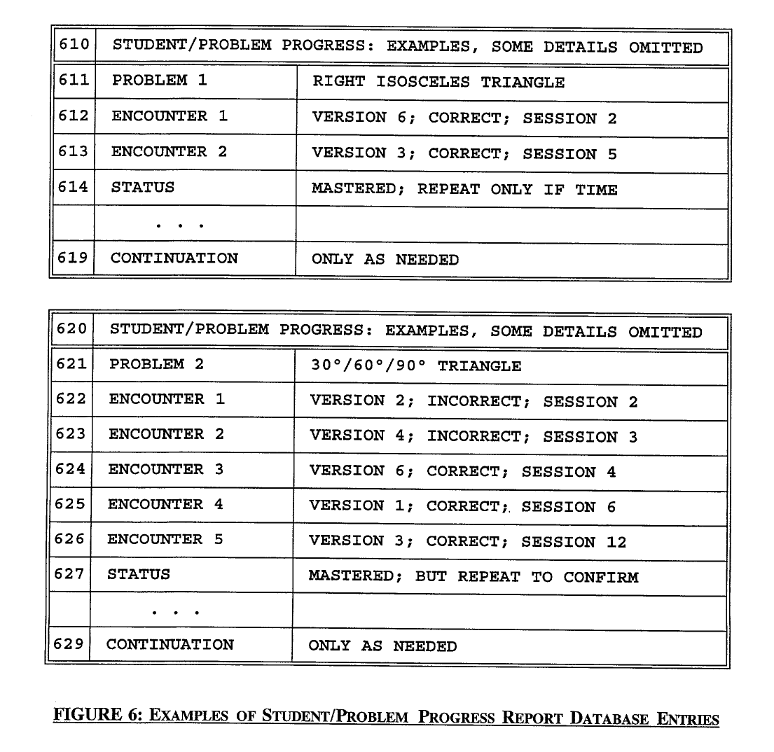

The interactive educational exchange described herein is illustrative, not limiting, and instructional designers and interactive programmers are those skilled in the appropriate art to create the educational media necessary for any particular application utilizing the instant invention. Following, a detailed discussion of a typical problem session will be provided with reference to FIGS. 6-9.

In the particular application being described here, the educational content is not, in and of itself, a full SAT review course. Rather, a small amount of practice material will be provided each day, and it is intended that the average student will spend approximately 5 to 15 minutes at each session. A typical standard session would consist of: for example, six math problems, two geometric, two algebraic, and two from other areas; and a similar amount of verbal practice, for example, three analogies, three antonyms, three fill-ins and a list of ten vocabulary words. Students may be signed up for math, verbal or both and, optionally, standard, intensive or ‘lite’ amounts of work may separately be specified for each (320). In some embodiments a particular presentation (e.g., standard verbal) will be the same for all students on a given day. Coordinated groups of students (for example from the same school, or review course, class) can be presented with identical daily practice sessions to encourage ‘post-mortem’ group discussions, perhaps on a bulletin board or chatroom supplied as part of the inventive service (also via 260).

In the preferred embodiment, however, once students begin to demonstrate mastery of some materials and not others, each student will be presented with a customized session geared towards their particular weaknesses. Optionally, artificial intelligence and expert system technology will be used to analyze each student's pattern of successes and failures, to determine cognitive strengths and weaknesses, and customize each student's presentation in a manner more sophisticated than merely removing mastered problems from an active list. This is particularly so when the subject matter is less routine than SAT practice sessions.

With reference to FIG. 6, the following assessment policy (610 & 620) is suggested as exemplary: When a particular type of problem—for example an ‘isosceles right triangle’ problem in math (611), or the ‘dearth/plethora antonym’ problem in the verbal area—is encountered for a first time, if it is answered correctly (612) this may be because of mastery or by chance. If the same type of problem (i.e., same mathematical principle, or same words, but arranged in a similar but not identical problem) is successfully answered the very next time it is encountered (613), it is marked as ‘mastered’ and is taken off the active list of practice problems (614); although, it will be presented again for further practice and confirmation of mastery if there is sufficient time during the study term after all other problem types have been marked as mastered.

Alternately, as shown in entry (620) in FIG. 6, if the first (as shown, or second) encounter with a particular type of problem results in an incorrect answer (622), then three consecutive correct answers to various versions (624-626) are required before marking the problem type as mastered (627) but, since it was not mastered from the outset, it is marked as a problem type to repeat for confirmation of mastery.

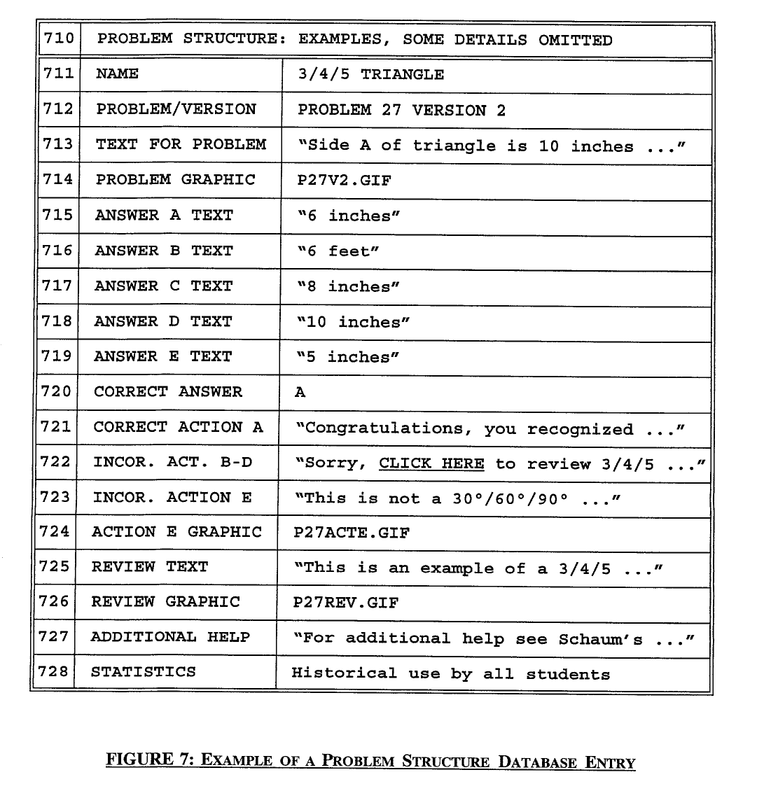

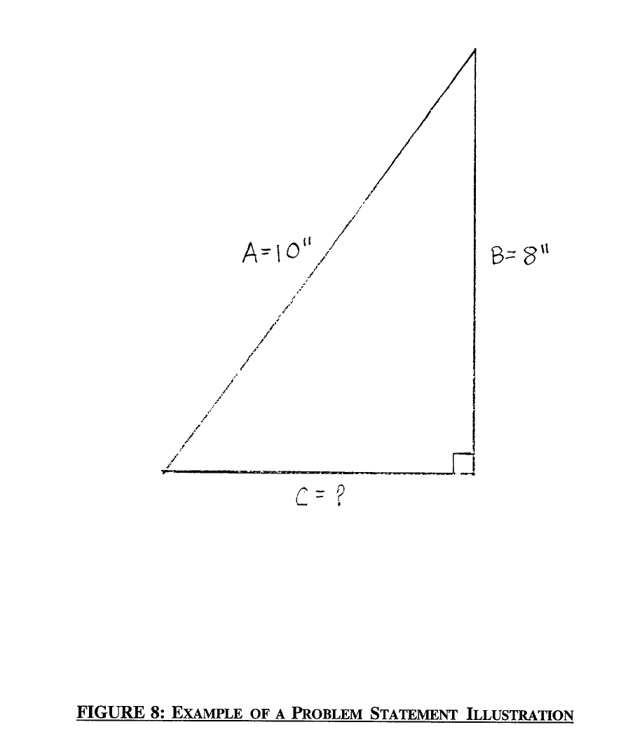

A typical database entry that is a ‘script’ for presenting a particular problem is shown in FIG. 7, (710). A problem type name (711) and problem type number/specific problem version (712) identify the problem. Entries for text (713) and the filename for one (or more) graphic (714, FIG. 8) comprise the problem statement. The text reads, in this example, “Side A of triangle is 10 inches, side B is 8 inches, angle CB is a right angle. What is the length of side C?” Text for five answer choices (715-719) A-E are also presented.

The student then enters their answer choice (260, 112). It is compared with the correct answer (720) and, if correct, the correct answer action text (721) is displayed: “Congratulations, you recognized this as a ‘3/4/5triangle’ type problem and selected the right answer. Review information may be displayed by clicking here. ” The review information (725) will include a brief tutorial (optionally including, possibly animated, graphics (726), which will be an extended, more general version of FIG. 8) and pointers to chapters or pages in a number of standard review books (e.g., Princeton, Barons, Schaum's, etc., 727).

If any generally wrong answer (B-D in this case) has been selected by the student, the appropriate text (722) is displayed, for example: “Sorry CLICK HERE to review the ‘3/4/5 triangle’ type problem.”0 With the hotlink sending the student to the same ‘review information’ described in the previous paragraph.

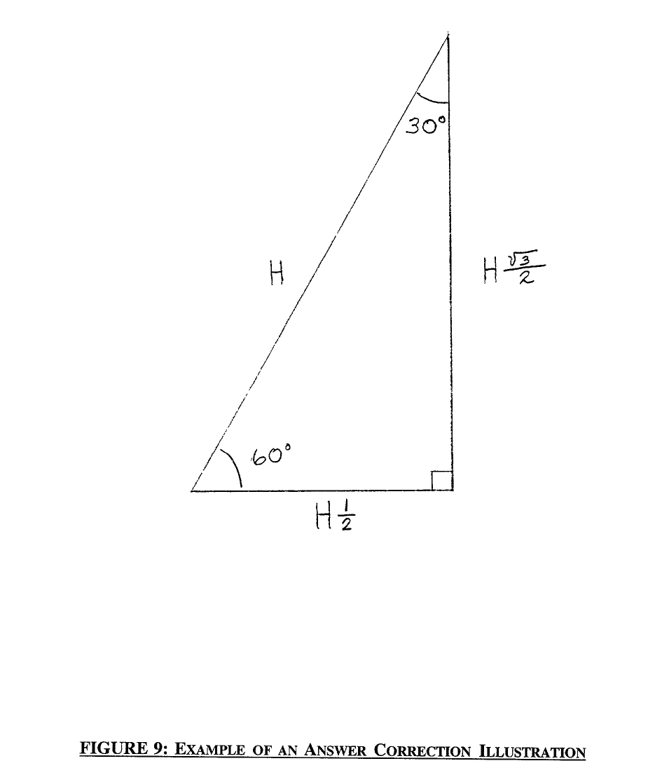

On the other hand, if answer E has been chosen, a different message of text (723) and graphic, including (724) FIG. 9, is displayed. In this case, the answer selected is not just wrong, it is a ‘distractor’, an answer that seems right (in this case because it fits the model for a ‘30°/60°/90° triangle’ not a ‘3/4/5 triangle’) but distracts the student from the correct answer. This answer indicates a cognitive mis-recognition and takes additional tutoring in order to ‘unlearn’ before correct learning can take place. For example: “This is not a 30°/60°/90° triangle but a 3/4/5 triangle. It is good that you learned to apply the ‘one half the hypotenuse rule’ but you are confused as exactly when to apply it. The 30°/60°/90° triangle problems (click here for more information) are usually stated in terms of angles and lengths. This problem, however, has a triangle with sides in the ratio of 3/4/5 (click here for more information) and the problem information was stated in terms of side lengths and a right angle instead of all angles.” Statistics (728) of how all students do with the particular problem are kept so that educational materials containing unrecognized defects can be uncovered. That is, when a large number of otherwise competent students provide a wrong answer to a particular problem, the problem statement and/or answer choices become suspect as being pedagogically defective. Further, it is useful to be able to report a particular student's performance in comparison to the group.

Lastly, with regard to student participation in sessions. Although it has been stated that ‘showing up to do the work’ is what counts and not a correct ‘score’, students cannot be permitted to just breeze through the session picking answers at random,just to collect the incentive rewards. Thus, the Java program, running locally on the student's machine, will monitor the student's actions; and, the combination of very fast answers and wrong answers will be flagged as ‘deceptive’ and, if it is severe or frequent enough, will be reported so on the parents' report (240). Thus, this invention will provide not only motivation, but monitoring and (via notification to parents) discipline.

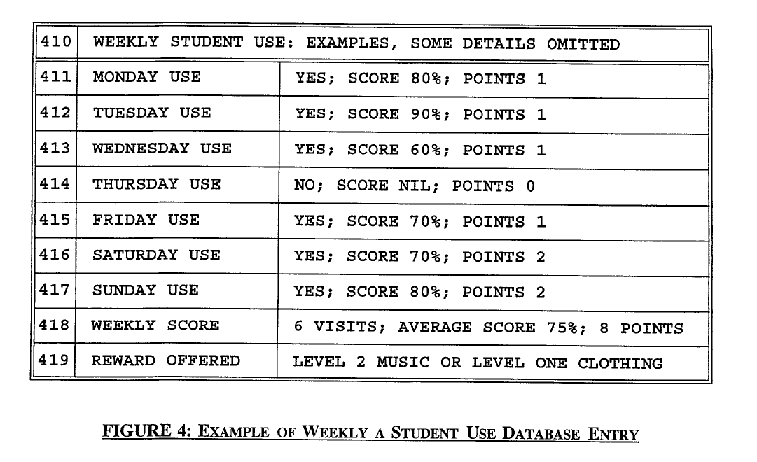

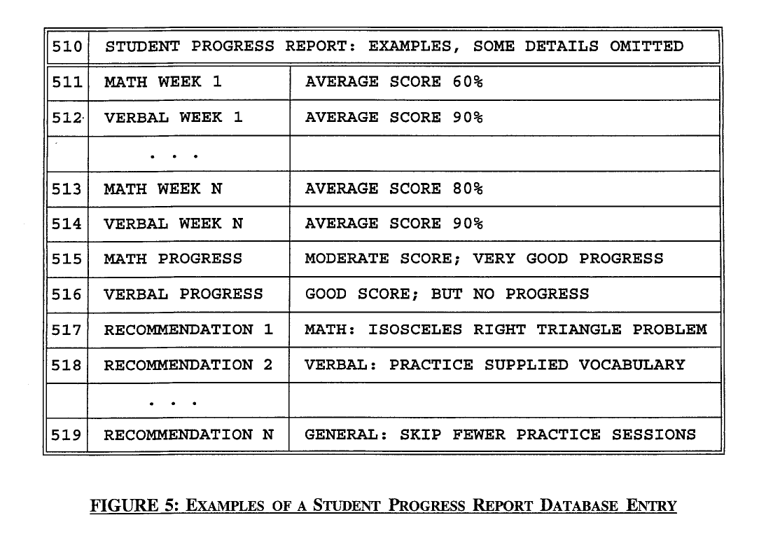

Computer (270) is, again, typically, a worldwide web client running a browsing program. Reports of: student use of the system (see also FIG. 4); their weekly progress or problems with various elements (e.g.: high level' math vs. verbal; mid-level—analogies vs. antonyms; low-level—the missed words dearth and plethora); comparisons against their own history, or other students; etc. will be made available to both students and parents. Database entries, such as those shown in FIGS. 5 and 6, will also be utilized to create these reports. Separate parent login and password will provide security from both students and the public. Students can, optionally, also access a version of progress/problem reporting. Reports can, optionally, be supplied via EMail, physical mail, telephone or FAX.

Computer (280) is, again, typically, a worldwide web client running a browsing program. Students will be offered rewards or incentives, as merchandise or discounts on merchandise or otherwise, in exchange for making use of the system. Generally, ‘showing up and doing the work’ is all that will be required to receive credit for an incentive, correct answers will not be required. Nevertheless, each week one (or more) students achieving the highest score, or improving the most, may receive some additional bonus.

A typical reward program is as follows: 1 point each day is given for doing the assigned practice questions Monday through Friday. Saturday and Sunday are worth 1 point for make up work if any weekday is missed, 2 points each if all five weekdays are also performed. (NOTE: the policy as shown in FIG. 4 is somewhat different.) At the end of each week those students receiving less than five points receive some minimum reward (e.g., a $1 discount on any CD bought at a physical Tower Records store, or via an online ‘music.com’ website) in order to satisfy our sponsor(s) needs to encourage students' patronizing their emporium (brick or online). Those students receiving 5-9 points receive a better reward (e.g., a $5-9 discount on purchase of two CDs with, perhaps, full nine points getting an even higher discount). In addition, optionally, the student(s) with the highest composite scores for the week (day) and/or the most improved student(s) of the week will get an even higher, or additional, incentive (e.g., two free CDs, value up to $25 total). Optionally, daily or occasional ‘instant’ or ‘surprise’ bonuses can be given after completing a single day's work (e.g., one free issue of Rolling Stone Magazine) in order to help encourage daily participation. Alternately, daily or weekly points may be accumulated over the length of several weeks or the entire program in order to select from a list of more valuable merchandise (e.g., if 9 points per week is the maximum obtainable, 40 points might entitle the student to half off a pair of Nike athletic shoes). One (or a small group of) sponsor(s) might supply incentives on a given week so that they will be supplying a large number of students; alternately, as above, a large number of incentives from many sponsors may be available (and, perhaps, saved up for) at all times. Incentives can include merchandise, samples or discounts, on items such as: music; books and magazines; videos and videogames; film, concert or other amusement tickets; cosmetics, shoes, clothing and accessories; sports equipment; health club or other memberships; vitamins, fast food or other consumables; diskettes and other computer or office supplies; film and photoprocessing; gasoline; telephone or online telecommunication charges; consumer electronics or other appliances; or, virtually any other commodity or service. Tie-ins with products that are available or, at least, promoted online will be particularly easy to create for the internet-mediated embodiments of the instant invention. Alternately, points or credits may be accumulated and converted to some sort of ECash, which may be spent, as the student sees fit, at many sites online.

Once sufficient work has been done, or credits accumulated, a student will select an incentive, typically by filling out a web page form. A reply web page may then be displayed for the student to print that will constitute a coupon to be redeemed by mail or at a local store. Alternately, and more securely, such a coupon may be mailed to the student. Coupons may be personalized or serialized for additional security (e.g., to prevent duplicating coupons not earned). In particular, a good compromise is to have pages of complex four-color official ‘blank’ coupons printed and then with a black and white laser printer (to be printed by the inventive service or—with a small number of blank official coupons given to each student at the establishment of the account—by the student) add student name, serial number, store and specific bonus, to create custom coupons that are not easily duplicated. Alternately, the information filled out at the web form may be forwarded to a sponsor (or fulfillment company) for merchandise or coupons to be shipped to the student (or whoever the student designates).

When parents establish an account for their student, they will have the option of specifying that certain classes of incentives (or any incentives at all) not be offered to their children. For example, some parents may not want their children to be offered music, or videos, or cosmetics (321). (Ideally, no tobacco, alcohol, ‘overly adult’ entertainment, or other inappropriate advertising or promotional incentives would be accepted by the inventive service.) The database entry (419) shown in FIG. 4 is typical of that used to specify student eligibility for incentives.

Computer (290) is, again, typically, a worldwide web client running a browsing program. Separate pages, banner advertisements, sponsorship emblems or graphics, or any other suitable method of advertising sponsors, will be worked into the educational website. Ideally, the distracting advertising will be kept separate from the pages actually used for educational content. But, students will, optionally, ‘pass through’ advertizing on the way to and from educational content. These ads may include hotlinks to the sponsors' websites and, in particular, may be keyed to the current (or earlier) incentive. (EMail or FAX or voicemail messages may also be used.) For example, a student who received a free issue of Rolling Stone Magazine as an incentive two weeks earlier might be shown a banner ad, or sent an EMail, suggesting the student now subscribe to the magazine, perhaps at a special discounted rate.

### UTILIZING AI TECHNOLOGY TO MAKE COMPUTERS MORE CAPABLE AND RESPONSIVE TO HUMAN COGNITIVE REQUIREMENTS OF TEACHING/LEARNING

The specific embodiments of the invention, described thus far, have focussed primarily on preparation for standardized tests. Nevertheless, the invention can be used in conjunction with any kind of educational materials for any purpose. Thus, the preparation of educational materials, in general—most likely computer-mediated—are appropriate to discuss. In particular, the preparation and presentation of customizable materials, utilizing Artificial Intelligence (AI) techniques will be disclosed next.

Some of what follows is rather specifically directed toward instructional media of a ‘tutorial’ nature; and, is also probably rather more applicable to domains of knowledge in mathematics and the sciences (both hard and soft), history, reading, etc.; and, less-so to the Arts. Nevertheless, AI also has more general applicability to educational technology.

Interactive educational multimedia authoring systems that merely provide the teacher/author with a set of empty templates—ready to be filled with text, images and other content that constitutes the teacher/author's knowledge base —impose a pre-programmed structure on the interactive work. They preclude the teacher/author from imparting their own personality and pedagogical style on the work.

In contrast, by providing the teacher/author an intelligent system with which to interact, not only is content collected, but the dynamic and relational elements of instruction are captured. These, in turn, along with other pedagogical structure supplied by the teacher/author and the authoring software, provide flexible and adaptive control mechanisms that permit individualized student access.

With interactive educational media, the computer is involved at two distinct times—during the authoring (teaching) process, and during the accessing (learning) process. AI and related technologies have much to offer during both phases of operation. Yet, AI technology has barely begun to be exploited to its fullest in the educational arena.

The requirement that current PCs provide capabilities such as downloading and displaying multimedia (including real-time audio, video and animation) results in computing power of immense proportions in even modest desktop systems. (Thus, as these standard desktop systems are suitable too run the software required for the instant invention, no hardware system diagrams have been provided. They are not necessary when suitable hardware is available off-the-shelf at any CompUSA or RadioShack.)

In contrast, the computational requirements for the computer ‘thinking’ algorithms that constitute AI, are relatively small. They can be fit into the interstices between media management and presentation tasks while hardly affecting performance. Thus, there is no technological limitation that would prevent AI from reasonably being incorporated into instructional media systems—either for authoring or for student access.

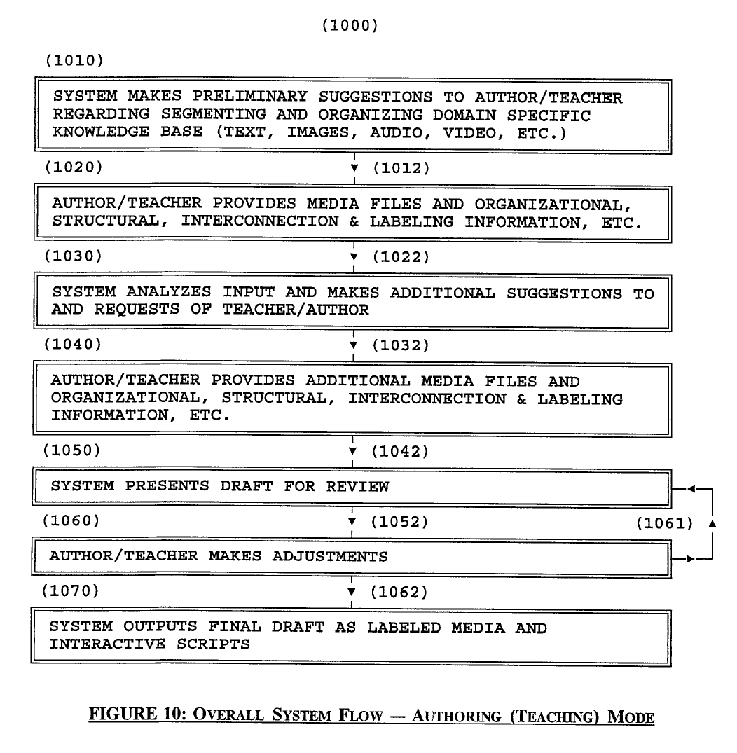

What is disclosed, below, is an intelligent educational software engine which, during a first phase, acts as an ‘instructional design advisor’ helping the author to deconstruct the knowledge domain into ‘atomic’ concepts; and to interrelate and organize them into a web of topics that may be navigated in a flexible manner (so long as prerequisite topics are encountered and mastered prior to later ones). During this phase, the authoring engine also acts with ‘expert naivety’ querying the author for alternative wordings, definitions, more (and less) detailed articulations, more (and less) complex articulations (suitable for different aged or sophistication of audiences), further explanations, remedial references, examples, illustrations, etc., as only the most dogged of students would. See FIG. 10.

The text, illustrations and other media provided during this first (authoring) phase constitute the knowledge-base to be accessed during the second (student) phase. However, more importantly, the interactions between computer and author during the first phase, are transformed into the interactive structure that flexibly controls student access during the second phase. That is, the author/computer interaction and the student/computer interaction are (in an oversimplified notion) convex and concave aspects of the same structure; with the authoring phase creating a ‘hollow mold’ from which knowledgeable students can be cast. In a more technical analogy, they are duals of each other, in the algebraic or graph theoretical sense.

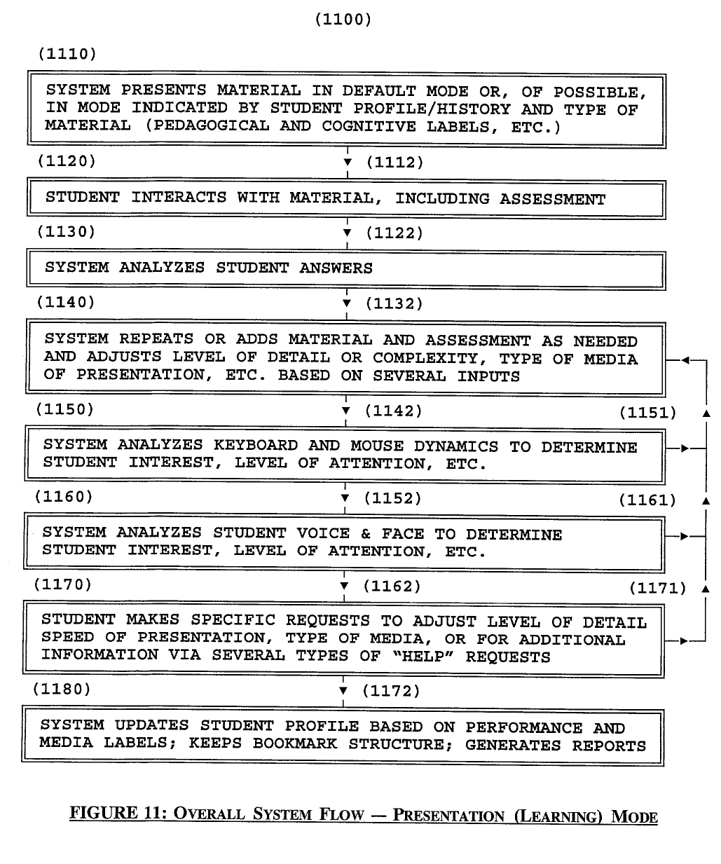

The interactive structure, resulting from the first phase, is bundled with the text, illustrations and other media, and supplied to the ‘learning engine’ which controls the second phase of presentation to/access by the student. In this mode, the engine is expert at monitoring student progress—as well as taking student direction—and presenting the multimedia knowledge-base at a speed, level of detail, and in a style, that is well-suited to the particular student's needs during that particular session. See FIG. 11.

AI DURING AUTHORING (TEACHING):

One of the difficulties in authoring interactive computer-mediated works (including instructional media) is that the authoring process requires someone to do programming. That is, in addition to being in command of the knowledge of the domain, as well as production of traditional content (be that text and static illustrations, or even audio, video and animation) the ‘author’ must specify and implement interactive structure, which can include: hyperlinks; alternative responses to student input or answers; help or glossary entries; cross-references; references to remedial material; etc.

If the author of traditional content is not also a computer programmer, then there are only two ways to proceed. One, is to work with a programmer, interactive producer, instructional technologist, or other specialist. Such team authoring is expensive, and takes control out of the content author's hands. Ideally—in the future—the author of an interactive work should be in as much control of the process and tools, as is the author of a text-only work who uses pad & pencil, typewriter, or wordprocessor.

The other alternative is for a venturesome, semi-computer-literate author to use a pre-programmed set of ‘templates’ (or template generation program) provided by some prior programmer. Traditional content is then ‘poured into’ a waiting, pre-structured, empty vessel. While this does get some version of the job done, it leads to a situation where all works using the same templates have the same look and feel. This, in itself, is not necessarily bad. For example, an academic department may want all of its on-line sites for classes to have the same interconnected set of pages: course outline, syllabus, professor's contact and office hours, lecture notes for each meeting, homework assignment for each meeting, etc. However, for more complex interactive works (e.g., a calculus unit teaching the concept of limit, or a physics unit teaching the first law of thermodynamics) an inflexible, pre-programmed template structure is not sufficient.

The author must be free to structure the interaction in order to best expose, re-enforce, and assess student progress.

Further, some traditional content authors do not want to take the time or effort to consider the interactive aspects of new media authoring.

For both these reasons, Artificial Intelligence, including Expert System and other technology, has great potential. For, example, expert systems techniques have been applied to domains as diverse as medical diagnosis and architectural design, creating tools that provide real assistance to seasoned professionals. A properly programmed expert system program will provide suggestions and alternatives for interactive structure, in response to the author's answers to the expert system's questions. Such a system, since it is a program, will then automatically generate the code, or links, or a custom template structure, to meet the needs specified in collaboration with the author. In this way, the pedagogical style or ‘personality’ of the author will be able to influence not just the content, but the interactive structure of such works as well.

Similarly, a human-scale, human-style statement (which is not necessarily verbal, but may be an indication made by menu choice, mouse click, etc.) made by the author (such as labeling a particular section of text as relating to a concept that is critical to master prior to proceeding to other some other sections) results in the expert system program generating code for a complex set of interactions, including assessment, and re-enforcement in the event of failure by a student to master the material. Such an expert system will, in fact, ask for such input as: “What question(s) would you ask to confirm mastery of this material?” and for each “What is a correct answer? . . . What is an expected wrong answer(s)? . . . If a student chose this wrong answer, what would you tell them, in order to clarify their understanding? . . . What re-enforcing or remedial material would you recommend presenting? . . . State that again, but in different language. . . . State that again, but in more (less) detail. . . . That term is unfamiliar—please supply a definition.” and so on. See FIGS. 10 and 12-15.

FIG. 10 depicts the overall interactive flow of information between the Expert System (acting as an expert multimedia producer, instructional media designer, educational psychologies, etc.) in the Teaching/Authoring phase (1000) and the Teacher/Author.

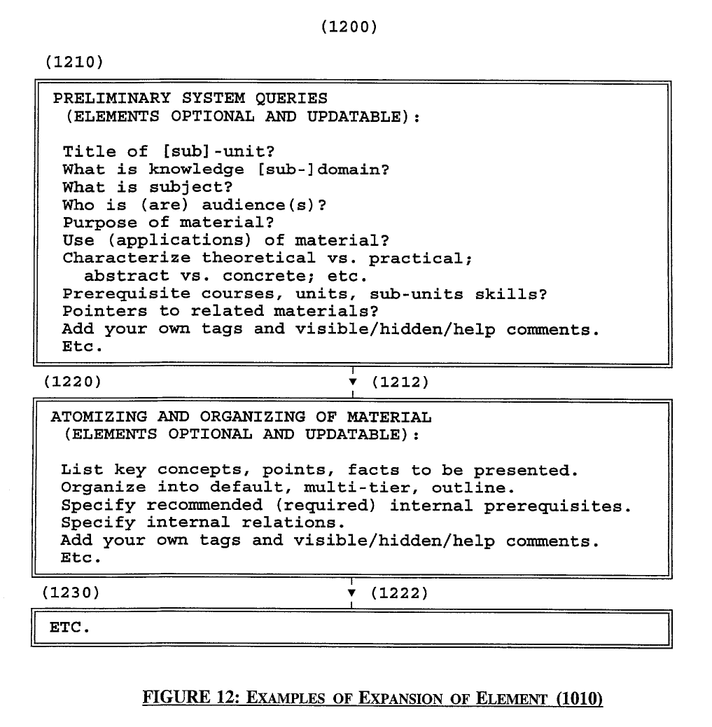

In (1010) the Expert System makes preliminary suggestions to the author/teacher regarding segmenting and organizing their domain specific knowledge base which comprises text, images, animation, audio, video, etc. See also FIG. 12.

In response (1020) the author/teacher responds, providing button and menu choices as well as typed responses; media files; and, organizational, structural, interconnection and labeling information, etc. Again, see also FIG. 12.

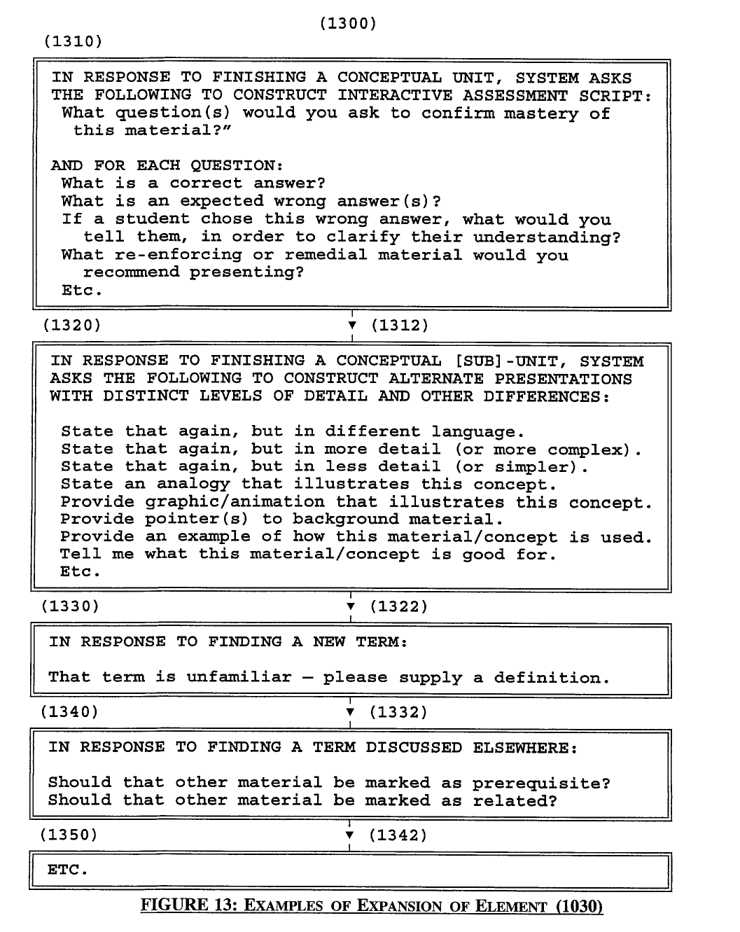

In (1030) the system analyzes the author/teacher input and makes additional suggestions to, and requests of, the teacher/author. See also FIG. 13-15.

In response (1040) the author/teacher provides additional media files and organizational, structural, interconnection & labeling information, etc. Again, see also FIG. 13-15.

In (1050) the system presents (1052) a draft of the materials for review by the author/teacher who makes adjustments (1060) which are fed-back (1061). This cycle is repeated by the author/teacher to their satisfaction; and, the work may also be exhaustively ‘exercised’ by another person (or a specially designed program) to ensure that there are no logical or procedural ‘holes’ such as links to nowhere, or a more detailed version where a less detailed version should be, or a missing piece of video or other media.

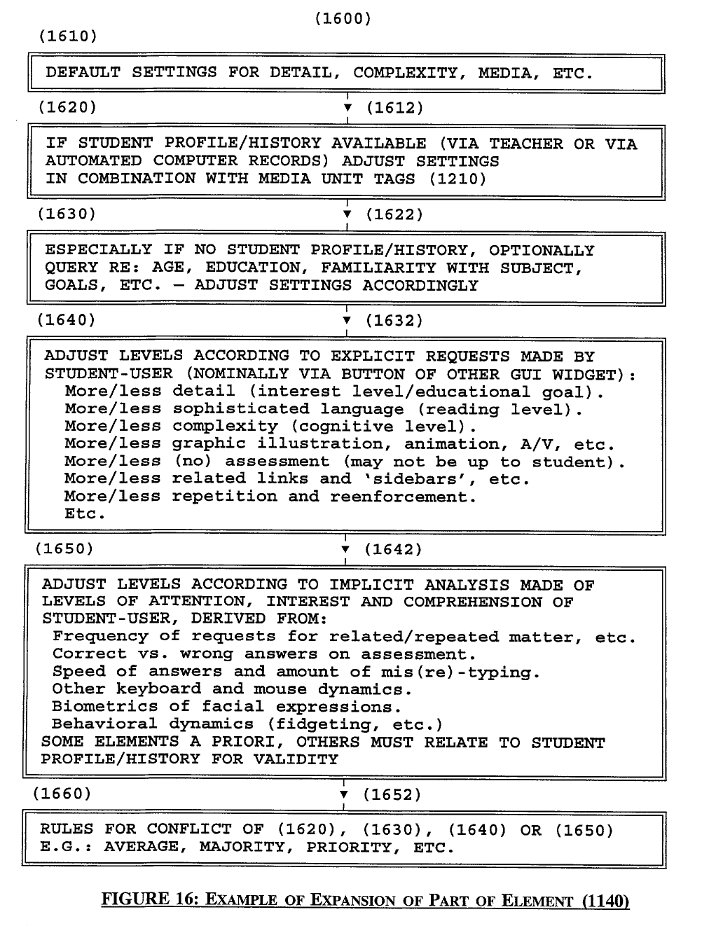

In (1070) the system outputs the final draft as a group of media files labeled with descriptions about content, level of detail, level of sophistication, cognitive requirements, prerequisite and related materials, etc.; and, interactive scripts that interconnect these media into a presentation that is flexibly customized upon access during the presentation/learning phase. (See FIGS. 11, 16 & 17).

FIG. 12 depicts examples of a more detailed expansion of the information flow of element (1010).

In (1210) this part of the system (1200) makes preliminary queries of the teacher/author. Some examples of queries/elements follow, and these are optional at the discretion of the teacher/author, and are updatable by the teacher/author. Queries include: What is the title of this pedagogical unit or sub-unit?; What is the knowledge domain or sub-domain covered?; What is subject matter?; Who is (are) the intended audience(s)?; What is (are) the purpose(s) of this material?; What is (are) the use(s) of or application(s) for this material?; Characterize this material on a scale of theoretical vs. practical. Characterize this material on a scale of abstract vs. concrete; Other pedagogical and cognitive characterizations, etc.; What are courses, units, sub-units, skills or other items prerequisite to learning this unit?; Supply pointers to related or remedial materials?; Add your own organizational and characterizing tags and visible, hidden, or help comments; Etc.

In (1220) the system advises and assists in the ‘atomizing’ (i.e., deconstructing) and organizing of the pedagogical material. Again, these elements are optional and updatable. Examples of interactive queries include: List the key concepts, points, facts, etc., to be presented in this unit; Organize these into a default, multi-tier, outline; Specify recommended, or required, internal prerequisites and ordering (vs. students perusing the material free-form); Specify internal relations between elements of this unit; Add your own organizational and characterizing tags and visible, hidden or help comments; Etc.

FIG. 13, depicts examples of a more detailed expansion of the information flow of element (1030). This phase of the system (1300) queries the author/teacher either during an interim period, continuously as appropriate, or upon completion of a pedagogical unit.

In (1310) the system asks the information used to construct interactive assessment scripts including: What question(s) would you ask to confirm mastery of this material? Then, for each question: What are acceptable correct answer(a)?; What is (are) an expected wrong answer(s)? And, for each wrong answer: If a student chose this wrong answer, what would you tell them, in order to clarify their understanding?; What re-enforcing or remedial material would you recommend presenting?; Etc.

In (1320) in response to finishing a conceptual unit or sub-unit (that is, a paragraph or single idea, smaller than the entire pedagogical unit or chapter) the system asks the teacher/author for alternative and elucidating material, in order to permit construction of alternate presentations with distinct levels of detail, levels of complexity, media style, and other differences. Requests include: State that again, but in different language; State that again, but in more detail (or more complex); State that again, but in less detail (or simpler); State an analogy that illustrates this concept; Provide graphic/animation that illustrates this concept; Provide pointer(s) to related, remedial, further or background material; Provide an example of how this material/concept is used; Tell me what this material/concept is good for; Etc.

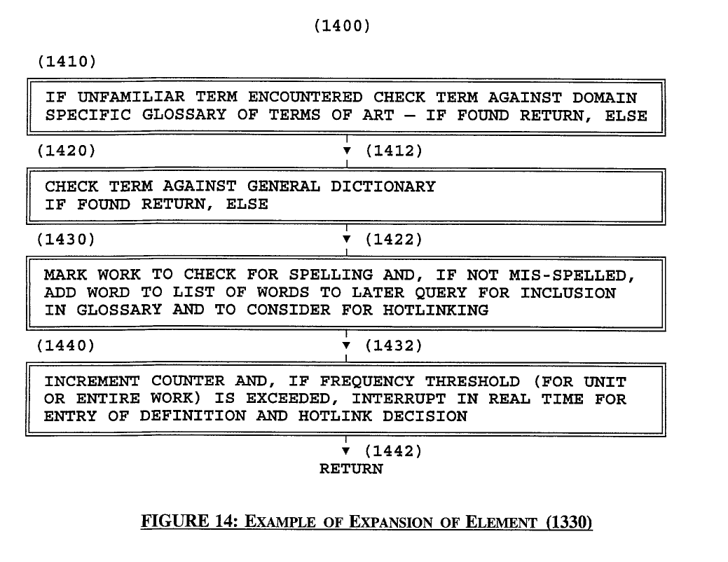

In (1330) in response to encountering a new term the system queries: That term is unfamiliar—please supply a definition. See also FIG. 14.

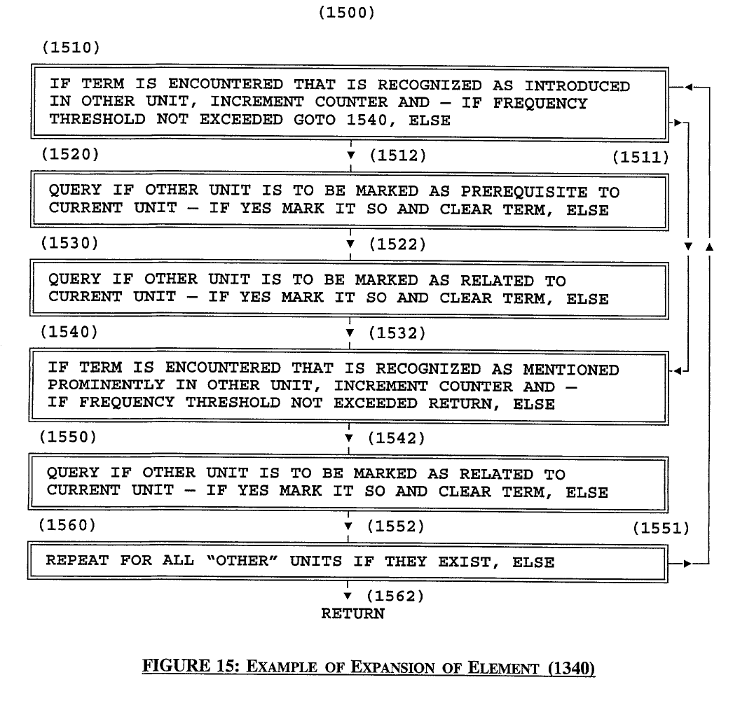

In (1340) in response to encountering a term discussed in another unit of the instant course, or in other material on the system the system will query: Should that other material be marked as prerequisite?; Should that other material be marked as related?; Etc. See also FIG. 15.

FIG. 14, depicts examples of a more detailed expansion of the information flow of element (1330). This phase of the system (1400) is called into play when an unfamiliar term is encountered.

First (1410) it is checked against a domain-specific glossary of terms of art. this is done first as it is expected to be a smaller list, and thus faster to compare to, than the full English (or language of choice) dictionary. If the word is found the definition is available for linking. Otherwise (1420) the term is checked against a general dictionary and, again, if found, the definition is available for linking.

Otherwise (1430) the term is marked to check for spelling (many unfamiliar words are just mis-typed) and, if not mis-spelled, add word to list of words to later query for inclusion in glossary and to consider for hotlinking.

Then (1440) a counter is incremented and, if a frequency of encountering threshold (for this particular unit, or for the entire coursework) is exceeded, the teacher/author is interrupted in real time for entry of a definition and decision as to whether the term should be included in a glossary and/or made a visible hotlink to the definition. (All words will be ‘clickable,’ in conjunction with a ‘look-up’ function, to bring up a definition which will check the unit glossary, course glossary, domain glossary, and general dictionary, in that order. Other words will be ‘hotlinked’ to additional material other than merely a definition.)

The teacher/author will also be given the opportunity to override one of the included dictionaries or glossaries for their own articulation of the definition that they feel more appropriate to the entire course, or an individual pedagogical or conceptual unit, or even just this one specific occurrence of the term. Often a particular context or use of a word calls for one particular definition (and, not necessarily the most natural or more usual one) and the teacher/author will, thus, be able to direct the system to show the correct choice, or type in a custom definition of their own. This may also be more than a simple definition but may discuss the etymology of the word, the background of a person or place name word, the inclusion of why a particular word is appropriate, a pun or other humor, etc. This is one of the ways the instant system permits the teacher/author to, in small ways, stamp the presentation with their own style and personality.

This low-level function flow depicted in FIG. 14 is an example of an ‘expert system rule’. That is, in expert systems, an expert in a field is interviewed by a knowledge engineer and programming rules are coded that mimic their recognition of situations and behaviors. The reason for including the frequency threshold is as follows.

A good instructional designer or multimedia producer would be on the lookout for terms of art that are familiar to the author they were assisting, but which might be unfamiliar to users of the finished work. They would keep a list of such terms so that, later, in consultation with the author, they could produce a glossary for inclusion with the work. However, authors often get annoyed with such ‘details’ and the task would often be skipped or sloughed off on an underling or the producer/editor themselves. On the other hand, if you interrupt the author as they are speaking (or, in this case, typing) every time they mis-spell a word or use a new term, you (the producer/editor, or the program) will soon wear out your welcome and be discussed or, at least, ignored.

So a balance is reached. If the same term is encountered frequently (higher than some adjustable threshold) in the specific unit or the entire work, then it is obviously an important concept. If a student finds this term unfamiliar, yet has no clickable definition available, their absorption of the material will be severely curtailed. (On the otherhand, a term used one or twice in an entire work may be mis-understood with less dire consequences.) So, for those terms that some up often, the producer may say: “Professor X, this ‘asymmetrical bio-statistical probe’ you keep mentioning, what exactly is that?”. Similarly, for important terms (that is, those that are both unfamiliar and encountered often) the system takes the chance of interrupting the author's train-of-though by querying in real time, but being relatively sure of getting a response. For less important terms, they are put on a list to run by the author at the end of a session, with the knowledge that such a wrap-up task may be skipped entirely, or answered with a perfunctory string of N, N, N, N, . . . in response to the computer's string of “Do you want to add this term to the glossary, or hotlink this term?”

Similarly, another expert system rule is depicted in the flow diagram of FIG. 15, which depicts examples of a more detailed expansion of the information flow of element (1340). This phase of the system (1500) is called into play when a familiar (as opposed to an unfamiliar) term is encountered.

In (1510) a term is encountered that is recognized as being introduced (i.e., is labeled as, or included in, the title or subject, of a conceptual or pedagogical unit) in another unit. In this case a different counter is incremented and, if the frequency threshold is not exceeded the program transfers to (1540). Otherwise, in (1520) the author/teacher is queried as to whether the material from this other unit is to be marked as prerequisite, to the material of the current unit. If the answer is yes, the term is marked appropriately and the term is cleared (and not checked further) for this particular combination of current and other units.

If it is not to be marked (strongly) as prerequisite, the author/teacher is queried further as to whether the material from this other unit is to be marked (weakly) as related, to the material of the current unit in (1530). Again, the term is marked as cleared from this combination of circumstances.

Similarly, in (1540) if the term is encountered and recognized as mentioned prominently (as opposed to introduced, and with prominently defined as exceeding another adjustable frequency threshold) in another unit, another counter is incremented and, if the frequency threshold is exceeded (1550) the system queries if the material of the other unit is to be marked as related to the material of the current unit. If the answer if yes, the term is marked appropriately and the term is cleared (and not checked further) for this particular combination of current and other units.

In (1560) the process is repeated (1551 back to 1510) with the same term in the current unit, but for all “other” units within the scope of materials set by the author.

What has ben described, above, is the operation of an expert system; but, one that is an expert ‘interactive instructional media producer’ not an ‘expert teacher in a given field of knowledge’. This program assists the teacher/author in organizing their educational knowledge of a particular domain in a pedagogically effective manner (as interactive structure). That expert authoring program will in turn, produce another program- the interactive instructional work—that will also incorporate elements of AI. That secondary program will, in effect, be an ‘expert teaching system’ that will assist the student in learning.

AI DURING STUDENT ACCESS (LEARNING):

It seems inevitable that computer technology, and computer-mediated instructional media, will increasingly find their way into the classroom. This is most likely a good thing. However, under budgetary pressure, they will be used as a substitute for human teacher-to-student instruction. This is not necessarily a good thing; and, if mismanaged, could spell disaster. Thus, it is imperative that such technology and media be developed to the highest possible level of effectiveness, in order to not short-change students.

One thing that is clear is that not all students learn at the same speed, or in the same style. One of the great advantages of human teachers is that they can recognize whether (and how) students are responding, and adjust their presentation accordingly—although, in a class of 30 students or more, the amount of individualized attention may be severely limited. While, the logistics of one-computer-to-one-student could theoretically provide individual (if automated) attention, that can only happen if the instructional software is capable of dong so. AI has great potential in this area.

Contemporary educational theory holds that simple mastery of content is not enough, and may not even be the most important element of educations. Rather, interaction with educational materials (as will as teachers and other students) is a vehicle to construct a model, or other knowledge, in the student's mind. Thus, a broad range of student interaction—or a flexible multi-tier access mechanism—needs to be authored (with AI assistance, as described above).

Similarly, a personalizable, student-oriented mode of access (monitored and controlled be an AI engine) is necessary to complete the equation.

If a fairly comprehensive domain-specific knowledge-base (i.e., content comprising text, images, audio, video, animation, etc.) has been properly organized during authoring, then such personalized instruction can be implemented. This is especially important at the ‘remedial’ and ‘gifted’ ends of the scale.

By monitoring student responses—to both ‘assessment’ and other factors—the presentation can be up—or down-shifted, or the style of presentation otherwise modified. For example: some students may respond better to terse statements of principle, while others require great detail, illustrations, analogies, many examples, or other cognitive support to learn easily; different students may respond well to different amounts, or frequency, of re-enforcement; and, the same student will perform differently when learning different types of material, or based on how alert they are at a particular time.

Student responses to questions confirming that material has been mastered (assessment) are traditionally used to determine what material to present next. However, in addition, the number of right or wrong answers, the speed of answers, and other factors, are used to assess student interest and attention and, further, to adjust the level of detail and complexity, type of media, type of pedagogy, or speed of the presentation—slowing and/or elucidating for students having trouble, for whatever reason. See (1650).

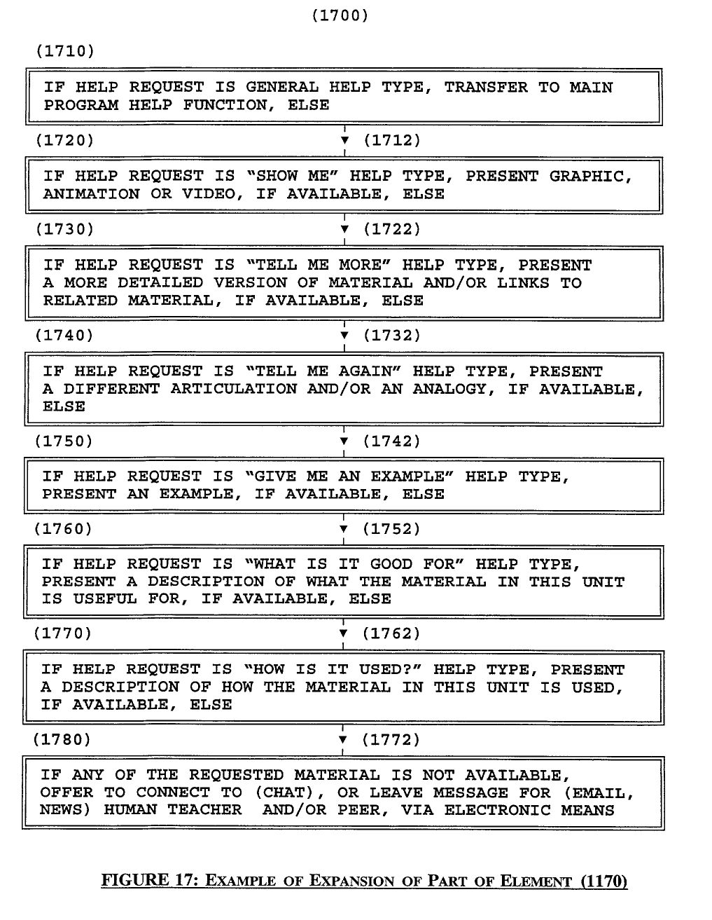

Alternately, students themselves are given “speed,” “detail” or other controls so that they can adjust to their own level of comfort. See (1640). Students are also given other mechanisms to customize presentation. While a generic “help” function is often provided in computer software, including instructional software, other more specific types of help requests (generally offered as clickable buttons or links) are more useful. For example: “SHOW ME” provides illustrations; “TELL ME MORE” provides a more detailed explanation, and/or links to related material; “TELL ME AGAIN” provides a different articulation or an analogy; “GIVE ME AN EXAMPLE” would do just that; etc. See FIG. 17.

An intelligent tutoring program can, optionally, take other measures of student ‘comfort’. These measures will be somewhat useful in an a priori or absolute sense. However, if the same student used the same computer often, the software keeps a student profile that would be consulted to note significant changes. For example, monitoring keyboard dynamics (e.g., how fast are responses typed in after presentation of questions? how often do typing mistakes need correction? etc.) or mouse dynamics (e.g., how jittery is the mouse movement? how much is the student ‘fidgeting’? etc.) provide useful measures of student interest in a particular subject, or attentiveness at a particular time. Presentation style adjustments are then made. Similarly, as PCs are more and more often equipped with microphones and video cameras for video-conferencing, students are monitored for: vocal response, eye-blinks, looking away, fidgeting, etc.; and, again, a measure of attention or interest is derived, and appropriate action taken. Generally, for bored students the presentation is made more terse and proceeds at a faster pace; for students not absorbing the material the presentation is slowed and elucidated. In this way, computers may be enabled to respond to ‘non-verbal cues’, and adjust presentation, just as good human teachers do. See (1650).

Similarly, student profiles based on information provided by teachers, the students themselves, or from computer observation of student behavior over time, are used to further customize presentations. See (1620). For example: some students need more/less help with abstract vs. concrete concepts; some students need more/less help with algebraic vs. geometric subjects; some students more easily absorb algebraic vs. geometric explanations for a given concept; some students prefer/more effectively absorb from text, graphics, animated graphics, audio, video; some students need more/less repetition; some students prefer structure, others the freedom to meander; etc. With the kind of rich interconnected multi-tiered knowledgebases constructed during the authoring phase of this system, presentations are easily customizable based on an individual student's needs.

Lastly, the appropriate action may, in fact, be to call for human (teacher, parent, peer, etc.) intervention. For example, see (1780). Perhaps the most intelligent element that can be incorporated into software is a ‘knowledge of its own limitations’.

FIG. 11 depicts the overall interactive flow of information between the Expert System (now acting as an expert teacher) in the Presentation/Learning phase (1100) and the Student/User.

In ( 1110) the Expert Presentation System presents material in the default system mode or, if available, in a mode indicated by student profile/history as appropriate for the type of material being presented as determined by the pedagogical and cognitive labels, etc., provided by the author/teacher, or analyzed by the system, during the authoring/teaching phase.

In (1120) the Student interacts with material, including assessment; and, in (1130) the system analyzes student answers, both for correctness and speed accuracy of input.

In (1140) the system repeats material, or adds remedial material, as well as repeats assessment, as needed. This interactive iterative presentation of material is what is historically common in computer aided instruction. However, the system of the instant invention also adjusts the level of detail or complexity, speed or terseness, and type of media of presentation, etc. These adjustments are based on several inputs. The general rule is that if a student is having trouble (based on wrong answers, especially repeatedly wrong answers, slow progress, worried facial expressions or other behavior, etc.): the pace of presentation is slowed; and, the presentation made simpler, more elucidated and better illustrated.

In (1150) the system analyzes keyboard and mouse dynamics to determine student interest, level of attention, etc. For example, fast accurate typing of material can indicate a confident student; hesitant, inaccurate typing the opposite. Fidgeting motions of the mouse, unrelated to actual interactive use, can indicate nervousness or boredom. And so on.

In (1160) the system analyzes student voice responses (e.g., for stress) and biometrics of facial expressions and dynamics to determine student interest, level of attention, etc. Again, expressions of concern or puzzlement vs. enthrallment vs. boredom can be recognized (by neural networks trained on a particular student, if not necessarily a priori) and appropriate action taken to down-shift (if concerned or puzzled) or up-shift (of bored) or mark and remember as ‘just right’ the various presentation settings. Data-mining of student performance and reaction to various combinations of material and presentation style will lead to developing student-specific profiles to use in predicting the best way to present later material of a particular type. Also, see (1180) AI systems (utilizing neural networks and other techniques) can be trained on a specific student (or a type of student group, e.g., inner-city six-year-old males) in order to develop good default profiles as a starting-point for future sessions with a particular student; or, as a good expectation for a new student who has been characterized. See (1630) for example.

As a useful byproduct, so long as keyboard dynamic analysis, voice response analysis, and/or biometric or neural network analysis of facial images are available, these can be used to confirm (to whatever degree of security is deemed appropriate) the identity of a student. This will be particularly important if actual exams or credits (e.g., SATs, CLE, CME, distance learning) are to be administered via a network, or to prevent students seeking rewards from sponsors by having a stand-in do the work for them. In particular, keyboard dynamic analysis (e.g., keystroke pattern vs. time) of the typing of the student's name or some other identifying phrase is a useful form of analysis, not unlike a signature.

Alternately (1170) the students themselves are provided with menus, buttons or other GUI widgets to make specific requests (1171 to 1140) to adjust the level of detail, level of complexity, speed of presentation, type of media, or for additional information via several types of “help” requests. See also FIG. 17.

In (1180) the system updates student profile based on a combination of student performance and embedded media labels (see discussion re: (1160), above). It also keeps a complex bookmark structure noting what material has been presented, which mastered, which bears repeating, etc. The system also generates reports for student, parent and teacher, as well as for statistical analysis.

FIG. 16 depicts examples of a more detailed expansion of the information flow of element (1340).

In (1610) the system starts with default settings (based on the system itself or on a set of defaults supplied with a particular interactive work) for detail, complexity, speed, media type, etc. However (1620), if a student profile, or history of student use with the system, is available, the system adjusts these settings based on this information in combination with media unit tags (1210) supplied by the author/teacher. The profile may be supplied by the student themselves, their teacher(s) or by mining the historical records of how the student has previously interacted with various kinds of educational material (e.g., math vs. reading; concrete vs. abstract; practical vs. theoretical) and various presentation styles (speed, detail, complexity, media type, etc.) in the past. See previous discussions regarding (1160) and (1180).

Alternately (1630) especially if no student profile/history is available, the student is, optionally, queried by the system regarding age, educational background, familiarity with the subject, educational goals, etc. And the settings are adjusted accordingly based on a set of expert system rules. In general, students who are older, better educated, more familiar with the subject, have serious goals are presented with more cognitively complex, more detailed (that is deeper, not more elucidating as this term is used in other contexts herein) and terser presentations.

In (1640) the system adjust the various levels and parameters according to explicit requests made by the student-user. Generally, these requests are made by clicking with the mouse and cursor on buttons, sliders, menus or other GUI ‘widgets’. These requests can include, for example: More or less detail relating to level of interest or educational goals); More or less sophisticated language, relating to reading level; More or less complexity relating to various cognitive skill levels and educational background and experience; More or less graphic illustration, animation, A/V, etc. relating to student comfort with text, etc.; More, less or no assessment, although this may not be up to student; More or less related links and ‘sidebars’, etc., again relating to student's preferences for presentation style; More or less repetition and reenforcement; Etc. All of these items mentioned here are also modified according to system analysis and assessment of student performance, even if not specifically mentioned.

In (1650) the system itself makes an implicit analysis (and adjusts the various levels and parameters accordingly) of levels of attention, interest and comprehension of the student-user. these are derived from: Frequency of student requests for related and/or repeated material, etc.; Correct vs. wrong answers on assessment and questions; Speed of answers and amount of mis-typing or re-typing required; Other keyboard and mouse dynamics; Biometrics of facial expressions; Behavioral dynamics (fidgeting, blinking, turning away, etc.). For some of these elements an a priori assessment can be made, while others must be related to a student's profile and/or history for validity. For example, long periods of looking away and fidgeting can pretty certainly be assessed as inattention. But one student's frown of consternation may be another student's expression of rapt contemplation.

Finally, in (1660) expert system rules resolve conflicts among inconsistent data derived from (1620), (1630), (1640) or (1650). For example conflicts may be resolved by: averaging data received from several sources, perhaps each waited for importance; taking a majority vote among sources; a priority ranking of sources; complex rules that are the combination of the previous; dynamically updated (e.g., if the first (expected) rule doesn't work well, try an alternate rule); etc.

FIG. 17 depicts examples of a more detailed expansion of the information flow of element (1170).

In (1710) this part of the system(1700) receives a help request and, if it is of a general help type, transfer is made to the main program (or system) help function.

Otherwise (1720) if the help request is of “show me” help type, a graphic, animation or video, is presented, if available.

Otherwise (1730) if the help request is of “tell me more” help type, a more detailed version of material and/or links to related material, are presented, if available.

Otherwise (1740) if the help request is of “tell me again” help type, a different articulation and/or an analogy, are presented, if available.

Otherwise (1750) if the help request is of “give me an example” help type, an example, is presented, if available.

Otherwise (1760) if the help request is of “what is it good for?” help type, a description of what the material in this unit is useful for, is presented if, available.

Otherwise (1770) if the help request is of “how is it used?” help type, a description of how the material in this unit is used, is presented, if available.

Otherwise (1780) if any of the requested material is not available, a message is sent to the terminal of an on-site teacher, the student is referred to the teacher, and/or and offer is made to the student to connect to (via live chat), or leave a message for (via Email or news/bbs) a human teacher and/or peer, via electronic means.

A Unified System

The ideas and principles described, thus far, are related, and can be integrated into a unified system.

The system first comprises a ‘bullet-proof’, AI-laced, generic ‘authoring engine’ suitable to produce interactive instructional media for any appropriate knowledge domain. That is, this system is well-suited for domains such as mathematics, the sciences (hard and soft), computer programming, and for some aspects of languages (reading and grammar, but less so poetry), history, etc.; but, would be less appropriate for teaching subjects such as art and literature.

It is acknowledged that this is not a new goal; and that others—for example, M. David Merril—have developed significant product in this area.

However, here, this ‘engine’ operates in two distinct phases or modes: an ‘authoring mode’ interacting with a teacher/author; and a ‘learning mode’ capable of interacting with a diverse population of students. Alternately, in practice, the system may exist as two separate engines. The designs, graphics, systems, programs and flowcharts, database entries, layouts, organizations, functions and business relationships described and depicted herein are exemplary, some elements may be ordered or structured differently, combined in a single step, skipped entirely, or accomplished in a different manner. However, the elements and embodiments depicted and described herein do work. In particular, the invention may be embodied as a largely automated internet-mediated system, or otherwise, as evolving computer and communications technology permits, and logistical requirements dictate. Content design, production, operation, delivery and distribution may be carried out by various methods and are, generally, not, in and of themselves, the substance of the instant invention. Substitutions of, variations on, and combinations with, other educational and technological elements, including artificial intelligence, now in use or later developed, is considered to be within the scope of the invention.

It will thus be seen that the objects set forth above, among those made apparent from the preceding description, are efficiently attained and certain changes may be made in carrying out the above method and in the construction set forth. Accordingly, it is intended that all matter contained in the above description or shown in the accompanying figures shall be interpreted as illustrative and not in a limiting sense.

Now that the invention has been described, what is claimed as new and desired to be secured by Letters Patent

1. An improved process for motivating students to utilize educational materials supplied by a provider, wherein said improvement comprises:
a. at least one sponsor;
b. at least one student who receives motivation to utilize said educational materials in the form of an incentive provided by said sponsor on condition that said educational materials are utilized in a specified manner monitored by said provider; and,
c. said sponsor receives promotional value from providing said incentive.

2. A process as in claim 1, wherein said incentive comprises as least some discount on the acquisition of at least one product associated with said sponsor.

3. A process as in claim 1, wherein said at least one sponsor comprises a multiplicity of sponsors.

4. A process as in claim 2, additionally comprising:
d. at least one authority;
e. said authority authorizes student participation; and,
f. said authority receives the benefit of the increased likelihood of improved utilization by said student.

5. A process as in claim 4, wherein said authority is a parent of said student.

6. A process as in claim 4, wherein said authority is an educator of said student.

7. A process as in claim 2, wherein said sponsor provides compensation to the entity providing said educational materials.

8. A process as in claim 4, wherein said authority provides compensation to the entity providing said educational materials.

9. A process as in claim 7, wherein said authority provides compensation to the entity providing said educational materials.

10. A system wherein the process of claim 2 is carried out, substantially in its entirety, in a computer-mediated manner.

11. A system wherein the process of claim 4 is carried out, substantially in its entirety, in a computer-mediated manner.

12. A system wherein the process of claim 7 is carried out, substantially in its entirety, in a computer-mediated manner.

13. A system wherein the process of claim 8 is carried out, substantially in its entirety, in a computer-mediated manner.

14. A system wherein the process of claim 9 is carried out, substantially in its entirety, in a computer-mediated manner.

15. A system as in claim 10, wherein in addition:
a. the choice of which material is presented to a student at any given time is based on an assessment of prior student performance.

16. A system as in claim 15, wherein said assessment is accomplished through the use of artificial intelligence computer techniques.

17. A system as in claim 10, wherein in addition:
a. the choice of which material is presented to a student at any given time is varied from student to student for the purpose of discouraging students from not doing their own work.

18. A system as in claim 10, wherein in addition:
a. deceptive student activity is detected.

19. A system as in claim 18, wherein said deceptive student activity is detected by noting low accuracy and high speed of student participation.

20. A system as in claim 18, wherein said deceptive student activity is detected by comparing an image of said student's face to a computer database image.

21. A system as in claim 18, wherein said deceptive student activity is detected by computer monitoring of student interaction at the keyboard, and wherein said monitoring includes the analysis of time versus keystroke pattern for at least one previously-entered identifying phrase.

22. A system as in claim 10, wherein in addition:
a. an image of said student's face is computer-monitored for the purposes of assessing student performance.

23. A system as in claim 10, wherein in addition:
a. student interaction at the keyboard is computer-monitored for the purposes of assessing student performance, and wherein said monitoring includes the analysis of time versus keystroke pattern.

24. A system as in claim 10, wherein in addition:
a. student performance and/or progress is reported.

25. A system as in claim 10, wherein in addition:
a. at least one element of said system operates, substantially in its entirety, via a computer network such as the Internet.

26. A system as in claim 10, wherein in addition:
a. at least one element of said system operates, substantially in its entirety, via automated voice response and telephone keypad entry.

27. A system as in claim 10, wherein in addition:
a. student-to-student electronic communication.

28. A system as in claim 10, wherein in addition:
a. electronic communication between student and educator.

29. A system as in claim 10, wherein said educational materials comprise a series of sessions encountered over an extended period of time.

30. A system as in claim 10, wherein said educational materials comprise a series of practice sessions for a standardized exam.

31. A system as in claim 10, wherein said educational materials comprise a series of practice sessions for a Scholastic Aptitude Test.

32. An system for motivating students to utilize educational materials wherein:
a. A provider supplies educational material comprising a series of computer mediated sessions;
b. A student accesses said educational materials to a required degree as assessed by said provider;
c. A sponsor provides motivation to the student to meet said required degree of access by supplying as least some discount on the acquisition of some product associated with said sponsor;
d. Sponsor receives promotional value from said acquisition; and,
e. Provider, optionally, receives compensation from said sponsor.

33. A system as in claim 32 wherein, in addition.
f. A parent receives the benefit of the increased likelihood of improved utilization of said educational materials by said student; and,
g. Provider, optionally, receives compensation from said parent.

34. An improved system for preparing interactive instructional multimedia wherein said improvement comprises:
a. the incorporation of an artificial intelligent engine and/or expert ‘instructional media designer’ system into a first phase wherein said system interacts with an author/teacher;
b. said system makes preliminary suggestions to said author/teacher regarding segmenting and organizing domain specific knowledge base elements;
c. said author/teacher provides media files and organizational, structural, interconnection and/or labeling information, to said system;
d. said system analyzes the information input in step c. and makes additional suggestions to, and requests of, said author/teacher;
e. said author/teacher optionally provides additional media files and organizational, structural, interconnection and/or labeling information, in response to step d.;
f. said system presents a draft presentation for review by said author/teacher;
g. said author/teacher optionally makes adjustments in response to step f.; and,
h. said system outputs final draft as labeled media and interactive scripts.

35. A system as in claim 34 wherein said improvement comprises, in addition:
a. the incorporation of an artificial intelligent engine and/or expert ‘teacher’ system into a second presentation/learning phase wherein said system interacts with a student/user;
b. said system presents material in a default mode or, if available, in a mode dictated by a student profile/history and the type of material as indicated by pedagogical and cognitive labels supplied during said first phase;
c. student interacts with material, including optional assessment;
d. said system analyzes student answers to said assessment;
e. said system repeats or adds material and assessment as needed per analysis of step d.;
f. said system optionally analyzes keyboard and mouse dynamics to determine level of said student interest, and/or level of attention;
g. said system optionally analyzes student voice and/or face to determine level of said student interest and/or level of attention;
h. said student optionally makes explicit requests to adjust level of detail or complexity, speed of presentation and/or type of media;
i. said student optionally makes explicit requests, or for additional information via several types of help requests;
j. said system adjusts level of detail or complexity, and/or type of media of presentation based on some combination of analyses in previous steps; and,
k. said system updates student profile based on performance and pedagogical and cognitive labels generated in said first phase.
